(19) United States
(12) Patent Application Publication
(10) Pub. No.: US 2021/0120018 A1
(43) Pub. Date: Apr. 22, 2021

(54) SYSTEMS AND METHODS FOR REACHING CONSENSUS IN A DECENTRALIZED NETWORK

(71) Applicant: Insolar Technologies GmbH, Zug (CH)

(72) Inventors: Kirill IVKUSHKIN, Moscow (RU); Vladimir STEPANOV, Moscow (RU); Pavel KIRILLOV, Moscow (RU); Andrei ZHULIN, Moscow (RU)

(21) Appl. No.: 17/076,272

(22) Filed: Oct. 21, 2020

Related U.S. Application Data
(60) Provisional application No. 62/924,245, filed on Oct. 22, 2019.

(51) Int. Cl. H04L 29/06; H04L 9/32; G06F 16/27

(52) U.S. Cl. CPC H04L 63/1416; G06F 16/27; H04L 9/3218

(57) ABSTRACT

Disclosed herein are methods and systems for achieving a consensus. In one exemplary aspect, a method may comprise sending and receiving phase 1 (P1) packets from a plurality of nodes in a blockchain network. The method may comprise forming, from the received P1 packets, neighborhoods each comprising a subset of the plurality of nodes. The method may comprise sending and receiving, from each respective neighborhood node of a respective neighborhood, a phase 2 (P2) packet comprising node state proofs received by the respective neighborhood node from other nodes within the respective neighborhood. The method may comprise comparing received P1 packets and received P2 packets to detect mismatching state information. In response to determining that at least a threshold amount of the nodes of the plurality of nodes have identified the same trusted and suspect nodes (based on the mismatching information), the method may comprise determining that the consensus is achieved.

### CROSS-REFERENCE TO RELATED APPLICATIONS

This application claims the benefit of U.S. Provisional Application No. 62/924,245, filed Oct. 22, 2019, which is herein incorporated by reference.

### FIELD OF TECHNOLOGY

The present disclosure relates generally to the field of blockchain technology, more specifically, to systems and methods for reaching consensus in a decentralized network.

### BACKGROUND

In distributed ledger technology (DLT) and blockchain systems, a consistent shared view of the network (e.g., showing node participation, trusted/malicious nodes, node capacities, etc.) between all nodes is essential for the network to be operational. To address violations of rules such as technical issues (e.g., timeouts) or malicious behavior (e.g., fraud), consensus algorithms are employed. Consensus algorithms allow for nodes to agree on whether new records to be added to the network are valid. Various consensus algorithms exist, among which the Byzantine Fault Tolerance (BFT) is a popular choice because of its desirable traits. In BFT, the list of nodes is permissioned and pre-defined, and all nodes have equal rights. To achieve a consensus agreeing on a transaction using BFT, a majority comprising ⅔ of nodes+1 votes is needed. However, consensus mechanisms that rely on traditional BFT are traffic intensive. This results in severe limitations on the network size and throughput. Whenever optimization mechanisms are utilized to mitigate the BFT inefficiencies, the so-called “BFT poisoning” problem arises, wherein a portion of the network transmits inconsistent data, leading the entire network to fail since it cannot discern which values are the correct ones. Thus, there exists a need to solve the consensus problem in a BFT-like way and to disseminate additional network state information (e.g., jet split/merge notifications, maintenance indicators, required actions, etc.).

### SUMMARY

To address these shortcomings, the present disclosure describes methods and systems for achieving a consensus. In one exemplary aspect, a method may comprise sending and receiving phase 1 (P1) packets from a plurality of nodes in a blockchain network, wherein each P1 packet comprises a respective node state proof (NSP), respective pulse data, and a respective node announcement of a respective node, wherein the respective node state proof is a signed hash value of a work log completed by the respective node. The method may comprise forming, from the received P1 packets, a plurality of neighborhoods each comprising a subset of the plurality of nodes. The method may comprise sending and receiving, from each respective neighborhood node of a respective neighborhood, a phase 2 (P2) packet comprising node state proofs and node announcements received by the respective neighborhood node from other nodes within the respective neighborhood. The method may comprise comparing received P1 packets originating from the other nodes within the respective neighborhood and each received P2 packet to detect mismatching state information. Based on the comparison of the packets, the method may comprise identifying trusted nodes and suspect nodes in the plurality of nodes. In response to determining that at least a threshold amount of the nodes of the plurality of nodes have identified the same trusted and suspect nodes, the method may comprise determining that the consensus is achieved.

In some aspects, the method may comprise removing the suspect nodes from participating in subsequent rounds of the consensus.

In some aspects, the method for identifying the trusted nodes and the suspect nodes in the plurality of nodes may comprise identifying, in the received P1 packets, first state information received from a first node and identifying, in a received P2 packet, second state information received from the first node by a second node of the respective neighborhood. In response to determining that the first state information and the second state information do not match, the method may comprise identifying the first node as one of the suspect nodes. In response to determining that the first state information and the second state information match, the method may comprise identifying the first node as one of the trusted nodes.

In some aspects, the method may comprise determining a size of each respective neighborhood of the plurality of neighborhoods such that the plurality of neighborhoods do not share the same node and minimize communication traffic between the plurality of nodes.

In some aspects, the threshold amount of nodes is at least ⅔ of the plurality of nodes.

In some aspects, the method for identifying the trusted nodes and the suspect nodes may further comprise calculating a hash and bitmask of each of the trusted nodes and the suspect nodes for distribution to the plurality of nodes in phase 3 (P3) packets.

In some aspects, the method may comprise calculating a node state proof (NSP) for transmittal to at least one node of the plurality of nodes in at least one P1 packet in response to receiving a pulse comprising a timestamp, a sequence number and entropy, wherein the pulse is a signal indicating a new processing cycle.

In some aspects, the method for calculating the NSP may comprise determining whether the NSP calculation is complete after a pre-defined timeout has expired and in response to determining that the NSP calculation is not complete, transmitting the at least one P1 packet without the NSP to the at least one node. The method may comprise subsequently transmitting the NSP to the at least one node when the NSP calculation is complete.

In some aspects, communication between different Globulas is carried out through a leader-based protocol, wherein the first Globula comprises the plurality of nodes and a second Globula comprises an additional plurality of nodes.

In some aspects, a leader of the Globula is selected by data based on a previous processing cycle (e.g., prior to sending and receiving phase 1 packets).

It should be noted that the methods described above may be implemented in a system comprising a hardware processor. Alternatively, the methods may be implemented using computer executable instructions of a non-transitory computer readable medium.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of a system for maintaining and storing a distributed ledger of records.

FIG. 2 is a flow diagram of a method illustrating a first phase of consensus.

FIG. 3 is a flow diagram of a method illustrating a second phase of consensus.

FIG. 4 is a block diagram of a network split into neighborhoods.

FIG. 5 is a flow diagram of a method illustrating a third and fourth phase of consensus.

FIG. 6 is a flow diagram illustrating a method for achieving a consensus.

FIG. 7 is a block diagram of a computer system on which the disclosed system and method can be implemented according to an exemplary aspect.

### DETAILED DESCRIPTION

Exemplary aspects are described herein in the context of a system, method, and computer program product for achieving consensus in four phases. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

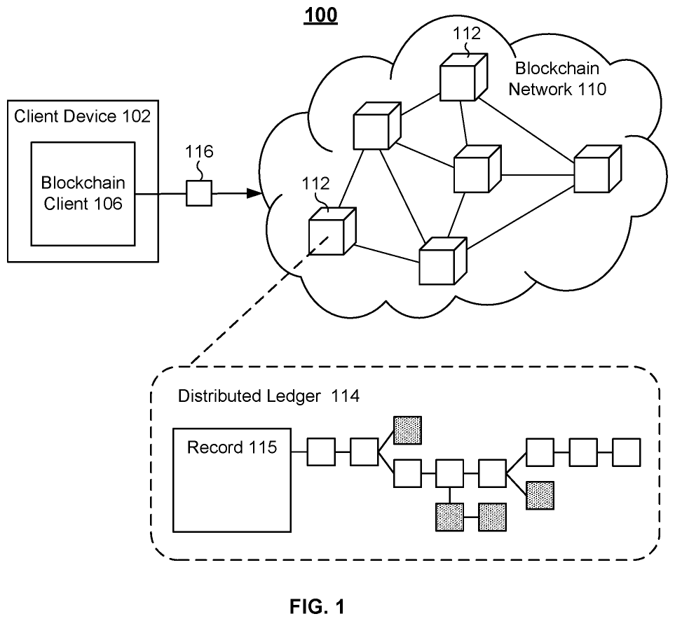

FIG. 1 is a block diagram of system 100 for maintaining and storing a distributed ledger of records, according to an exemplary aspect. System 100 may include one or more client device(s) 102 communicatively connected to blockchain network 110. Client device 102 may be one of personal computers, servers, laptops, tablets, mobile devices, smart phones, cellular devices, portable gaming devices, media players or any other suitable devices that can retain, manipulate and transfer data. Client device 102 may include a blockchain client 106, which is a software application configured to generate and transmit one or more blockchain-based transactions or messages 116 to blockchain network 110 for accessing or modifying records stored in the distributed ledger, such as maintaining user accounts, the transfer of cryptographic assets to and from such user accounts, and other types of operations.

According to an exemplary aspect, blockchain network 110 can be a distributed peer-to-peer network formed from a plurality of nodes 112 (computing devices) that collectively maintain distributed ledger 114, which may contain one or more blockchains 114. For purposes of the present discussion, the terms distributed ledger and blockchain may be interchangeably used. Blockchain 114 is a continuously-growing list of data records hardened against tampering and revision using cryptography and is composed of data structure blocks that hold the data received from other nodes 112 or other client nodes, including the client device 102 executing an instance of the blockchain client 106. The blockchain client 106 is configured to transmit data values to the blockchain network 110 as a transaction data structure 116, and nodes 112 in the blockchain network record and validate/confirm when and in what sequence the data transactions enter and are logged in blockchain 114.

The distributed ledger may be organized into multiple blockchains 114 which are configured to ensure chronological and immutable storage of data. In one aspect, the distributed ledger may include one or more lifeline blockchains, sideline blockchains, and jet blockchains. In one implementation, lifeline blockchains are individual blockchains in which each data object and all its states are stored (i.e., objects are treated as individual blockchains). Lifeline blockchains can have logic and code associated with them, so the terms lifeline blockchain, object, and smart contract may be used interchangeably. In one aspect, sideline blockchains are utility lifeline blockchains used to store temporary or auxiliary data such as indexes, pending operations, or debug logs. A lifeline blockchain can have several associated sideline blockchains to store information. A jet blockchain may be configured to act as a shard or partition which make up storage blocks and form shard chains. Records in a jet blockchain may be first produced by a lifeline blockchain, then packaged into blocks, and placed in sequence to form a chain of blocks. Replication and distribution of data can be managed individually by blocks and jet blockchains. The use of multiple kinds of blockchains enables dynamic reconfiguration of storage by splitting and merging of jet blocks without compromising data immutability.

Distributed ledgers (e.g., blockchain 114) are used to store a plurality of records 115, which may contain information such as a request, a response, a control of state, and maintenance details. In known approaches to blockchain technology, records 115 of a distributed ledger are ordered chronologically by time of creation or registration, and each record of a ledger may represent an operation (or a change) made and can have a reference to a previous record which represents a baseline for the operation. The reference uniquely identifies an entity (e.g., record) and is based on or includes information (e.g., checksum, hash, or signature) to validate the integrity of the entity the reference points to. Blockchain 114 is configured such that record 115 contained in the blockchain contains a reference to a previous record and hash information.

Consensus can be implemented in the networking layer of decentralized systems (e.g., system 100) or in a consistent, decentralized network aimed at solving certain computational tasks. In an exemplary aspect, there are four phases in the consensus (phase 1, 2, 3, and 4). During each phase, all nodes 112 communicate a certain set of information with each other.

In particular, individual nodes talk to other nodes. When talking to some node X, a node first sends and receives phase 1 packets, then phase 2, etc. Two particular nodes cannot exchange phase N+1 packets before they have exchanged phase N packets because, in terms of packet content, there exists a dependency of N+1 on N (due to the fact that phase 1 involves the collection of data). It should be noted that phases run concurrently across all nodes, and develop according to what information is received from the previous phase(s).

Some nodes, however, may receive data early and begin disseminating packets of phase 2 before other nodes have been able to distribute their node state proof (NSP) at phase 1. This can happen for various reasons, including, but not limited to, nodes working at different speeds due to processing power, or different/unbalanced workloads, or nodes receiving a pulse which designates the start of a new object processing cycle. Thus, different nodes can be on different phases when talking to some particular other nodes. This is why phasing is sequential between each particular pair of nodes, but the network, as a whole, is not at some particular phase.

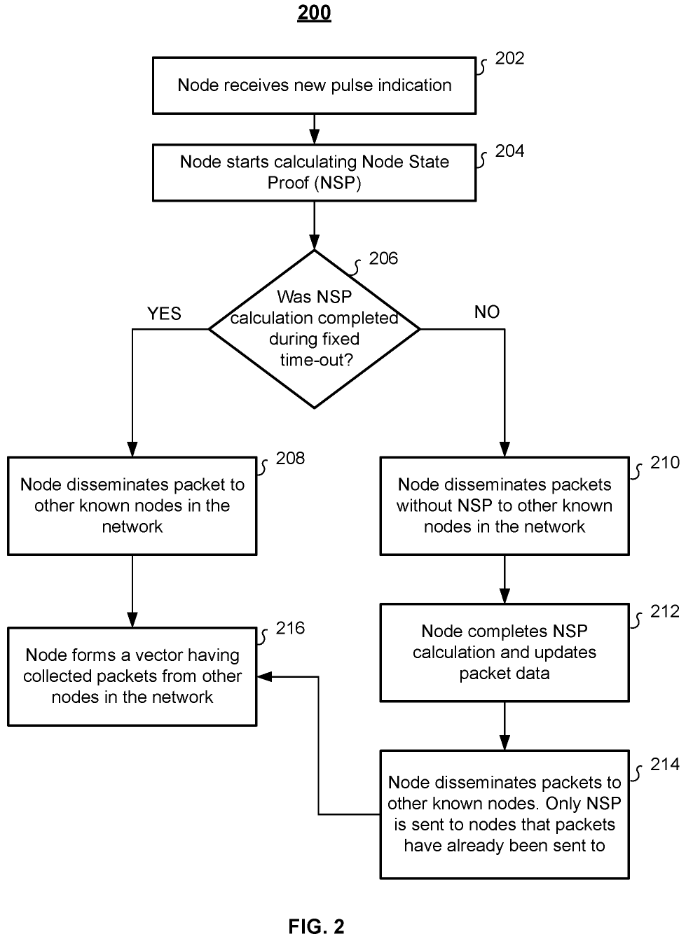

FIG. 2 is a flow diagram of method 200 illustrating a first phase of consensus, according to exemplary aspects of the present disclosure. The primary goal of consensus is to reach a consistent shared view of pulse data and the set of active nodes on network 110. Phase 1 initiates consensus with the announcement of a pulse and the distributions of individual states.

A pulse is a quasi-periodic signal carrying (1) a timestamp, (2) a monotonically increasing sequence number, and (3) entropy (source of randomness). A pulse triggers the start of a new network cycle (used interchangeably with object processing cycle), which comprises a consensus round. In some aspects, a pulse may refer to either a network cycle itself or an event of starting a new network cycle. Pulses are generated by Pulsars, which may be special devices or nodes running the Insolar Pulsar Protocol. Pulses can also be produced by any other protocol which satisfies the similar basic requirements as to sequence number, timestamping and entropy. Pulsars are separate from the Insolar Globula Network (e.g., network 110).

In some aspects, the Insolar Cloud is a collection of Globulas, each of which consists of up to 1,000 nodes. Globulas communicate with each other through a leader-based protocol, for example, they can choose a leader using data from the previous pulse.

Each node 112 of network 110 maintains an active node list and may introduce new nodes into network 110. In some aspects, only one new node may be introduced by an already participating node during each pulse.

Each node 112 in network 110 may hash object processing requests (e.g., transactions) to generate a node state hash (NSH). NSHs are hashed information about all object processing requests a node 112 has completed since the previous object processing cycle (i.e., pulse). More specifically, NSHs serve as proof of a certain work log completed by the node 112 during the previous object processing cycle. Node state proof (NSP) is a signed node state hash and signature. NSPs enable the generation of a shared state across all nodes 112 of network 110. Each NSP carries a node state hash and nodeSignature, wherein the nodeSignature=sign(hash(nodeStateHash, pulseHash)). One goal of consensus is to ensure that all nodes in a network see all other node's states (NSPs) and those states are equal. In some aspects, the NSP protocol can propagate auxiliary data along with the node state hash, such as software versions, instructions to perform updates, and notifications about cloud-wide events.

Along with pulse data and NSP, each node proposes an announcement to other nodes as to what role it is willing to perform henceforth. A node 112 may propose a “stay” status, a “leave” status, and possibly an introduction to a new node. For example, if a node 112 wants to stay in network 110, the node 112 indicates a “stay” status and provides an indication of capacity to compute and store, along with a role. If a node 112 wants to leave network 110, the node 112 indicates a “leave” status. Lastly, if a node 112 wants to propose a new node for joining network 110, the node 112 provides basic information such as a role and capacity of the new node.

Among the roles that a node may propose are: virtual node and light material node. Virtual nodes receive and handle requests to execute contracts, read the latest contract states, generate updates (e.g., new records) via material nodes, and handle contract-related data encryption. Light material nodes are a fast cache above heavy material nodes (which serve as long term storage). Light material nodes register incoming requests and register the results of processing of the incoming requests.

Method 200 starts at 202, where a node 112 receives a new pulse indication (e.g., from a Pulsar). In response to receiving the pulse, at 204, the node 112 starts calculating its node state proof (NSP). After a pre-defined timeout, which is an allocated time during which the node 112 calculates its NSP (the node 112 may still receive packets), method 200 advances to 206, where a determination is made on whether the NSP calculation was completed within the pre-defined timeout. In response to determining that the NSP calculation was completed, method 200 advances to 208, where the node 112 disseminates a phase 1 packet comprising pulse data, the calculated NSP and node announcement data, to other nodes known to the node 112 in the network 110. Node announcement data may comprise identifying credentials (e.g., a public key), static role, capacity in that role, etc. In some aspects, node announcement data is signed separately from the phase 1 packet. Consider the following notation for the phase 1 packet for node i:

P1ᵢ=[pulse,NSPᵢ,Aᵢ],

where pulse refers to pulse data, NSPᵢ is the calculated NSP, and A is the node announcement data.

If at 206, it is determined that the NSP calculation was not completed within the pre-defined timeout, method 200 advances to 210, where the node 112 disseminates the phase 1 packet without the calculated NSP to the other nodes known to the node 112 in the network 110. At 212, the node 112 completes the NSP calculation and updates the packet data. At 214, the node 112 disseminates the packet with the update to other known nodes. In order to save traffic, the node 112 only sends the calculated NSP to the other nodes that the packets have already been sent to.

From 208 and 214, method 200 advances to 216, where the node 112 forms a vector having collected packets from other nodes in network 110. For example, while node 112 may be sending packets to other nodes, node 112 may also be receiving packets from the other nodes. Based on these received packets, the node 112 forms the vector (later used to form node neighborhoods). Consider the following notation for a vector generated by node i:

Vᵢ=<P1₁,P1₂, . . . P1ᵢ₋₁>,

where the vector comprises a plurality of packets received by the other known nodes. The expanded notation is thus:

Vᵢ=<[pulse,NSP₁,A₁],[pulse,NSP₂,A₂], . . . [pulse,NSPᵢ₋₁,Aᵢ₋₁]>

Some nodes may start delivering differing data about their state to other nodes. For example, node 2 may send NSP₂ to node i, but NSP_{false} to node 1. When there is a sufficient number of such “malicious/fraudster” nodes (e.g., ⅓ of the total amount of nodes in network 110), then the majority of “good” nodes receive inconsistent information and thus cannot decide which other nodes are “good” or “malicious.” This occurrence is referred to as poisoning. This problem is relevant only in cases when some optimization of the BFT algorithm is employed, because, while saving hugely on traffic, a complete amount of information is not distributed and thus network 110 would need additional rounds of communication in case of finding such inconsistencies.

In some aspects, when a “malicious” node sends different states to all other nodes, no one particular node can detect the “malicious” node without having additional information from the other nodes in network 110. As a result, even one “malicious” node is enough for network 110 to become inconsistent. These issues are alleviated by phase 2.

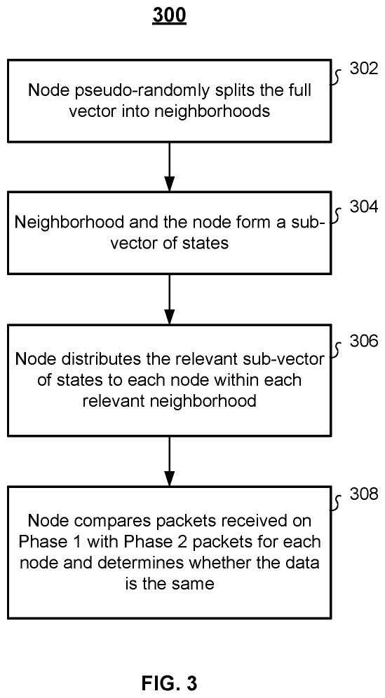

FIG. 3 is a flow diagram of method 300 illustrating a second phase of consensus, according to exemplary aspects of the present disclosure. Phase 2 involves the distribution of sub-vectors. At 302, each node 112 pseudo-randomly splits the formed vector of 216 (FIG. 2) into “neighborhoods” of fixed size. The number of nodes in a neighborhood for each node may vary. For example, in some aspects, the size of a neighborhood may be between 5-7 nodes. The size of a neighborhood is maximized to reduce internode traffic (i.e., more nodes in a neighborhood results in fewer neighborhoods, which results in fewer communications), but is split to no less than 5 nodes (including the node itself) to ensure uniform coverage. Uniform coverage refers to maximizing the likelihood that a malicious node is observed by several nodes. The size of a neighborhood may not be too large in order to avoid large overlaps in neighborhoods and save traffic of a given node 112, which can put the network consensus at risk of manipulation and larger packet sizes. Two limits are considered when determining neighborhood size: an upper limit is restricted by a technical packet size (as defined, for example, in UDP) and a lower limit defined by a probability that a node is getting a sufficient number of copies of other node states. In some aspects, the neighborhood size is the same for all nodes.

It should be noted that if there are N amount of nodes in network 110, at each phase there will be an order of N\hat{ }2 total communications (i.e., N nodes each send information to N−1 nodes) for a certain data calculation to be shared amongst all nodes. If n is the number of nodes in a neighborhood, the whole amount of traffic to exchange is of the order of n*N\hat{ }2*(size of one node info).

At 304, each neighborhood and a respective node 112 form a sub-vector of states. Consider an example in which there are 20 nodes and four neighborhoods are formed, each with five nodes. Node i may be in a neighborhood with nodes 1, 2, 3, and 4. Each node in the neighborhood may generate a respective sub-vector of states comprising the states transmitted by one another. Consider the following notation of a sub-vector for node i:

SVᵢ=<P1₁,P1₂,P1₃,P1₄>,

where the expanded notation is:

SVᵢ=<[pulse,NSP₁,A₁],[pulse,NSP₂,A₂],[pulse,NSP₃,A₃],[pulse,NSP₄,A₄]>

Likewise, nodes 1-4 may generate their own sub-vectors comprising the phase 1 packets they received from the members in the neighborhood. For example, the sub-vector of node 1 may be:

SV₁=<P1ᵢ,P1₂,P1₃,P1₄>

However, as discussed previously, node 2 may have sent node 1 a different/false NSP. Thus, the expanded notation would be:

SV₁=<[pulse,NSPᵢ,Aᵢ],[pulse,NSP_{false},A₂],[pulse,NSP₃,A₃],[pulse,NSP₄,A₄]>

In some aspects, along with this state information, additional info may be included in a phase 2 packet. This additional information may include jet split/merge info, version of platform software, activation of features (after the features have been installed on the node 112), performance and stability diagnostics (e.g., info on some errors detected) and any high-level information produced by logic running on the node 112.

At 306, the node 112 distributes the relevant sub-vector of states to each node within each relevant neighborhood (i.e., to nodes whose states are included in the sub-vector) in phase 2 packets. Upon receiving the phase 2 packets from other nodes, but not necessarily all nodes, each node can decide whether its peer nodes are “malicious” or “good.” This is performed at 308, where the node 112 compares packets received in phase 1 (directly from the analyzed node) and phase 2 (from one or more other nodes) from each node and determines whether the data within the respective packets is the same. For example, a first node may know about a second node through a phase 1 packet received from the second node. In phase 2, the first node can verify that the second node is “good” in response to receiving information about the second node from at least one other node of network 110.

In the overarching example, node 1 may receive a phase 2 packet P2ᵢ=[SVᵢ] from node i, and compare the contents of the sub-vector with its generated vector V₁.

V₁=<[pulse,NSP_{false},A₂], . . . [pulse,NSPᵢ,Aᵢ]>

SVᵢ=<[pulse,NSP₁,A₁],[pulse,NSP₂,A₂],[pulse,NSP₃,A₃],[pulse,NSP₄,A₄]>

As can be seen, the NSP received by node i from node 2, as indicated in SVi, does not match the NSP received by node 1 from node 2. Accordingly, node 1 may determine that node 2 is not “good.” Likewise, from the perspective of node i, which may receive a phase 2 packet P2₁=[SV₁] from node 1, may compare the received data with its generated vector, namely:

Vᵢ=<[pulse,NSP₁,A₁],[pulse,NSP₂,A₂], . . . [pulse,NSPᵢ₋₁,Aᵢ₋₁]>

SV₁=<[pulse,NSPᵢ,Aᵢ],[pulse,NSP_{false},A₂],[pulse,NSP₃,A₃],[pulse,NSP₄,A₄]>

Node i may thus also determine the mismatch between NSP₂ and NSP_{false}. In response to determining that both NSPs originated from node 2, node i may also label node 2 as not being “good.”

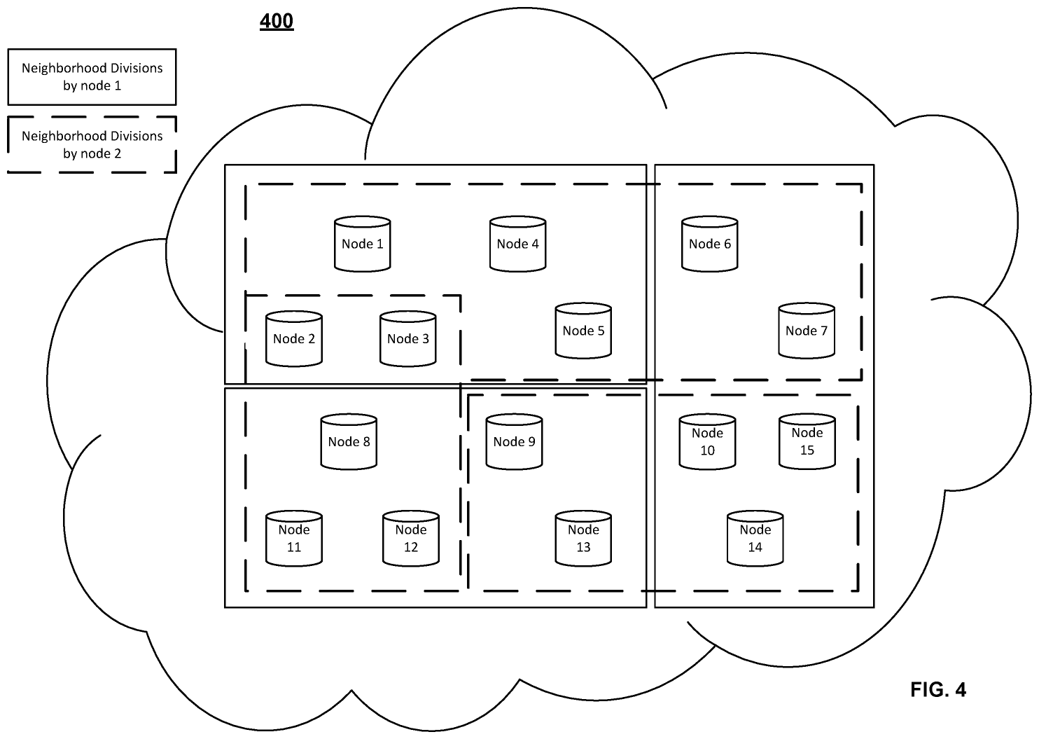

FIG. 4 is a block diagram of a network 400 split into neighborhoods, according to an exemplary aspect. In some aspects, the neighborhoods generated by each node may be different. For example, in FIG. 4, node 1 splits the network 400 into three neighborhoods, demarcated by a solid line. Node 2 also splits the network into three neighborhoods, demarcated by a dashed line. Both sets of neighborhoods comprise a different nodes, but there are clear overlaps between the respective neighborhoods of the respective nodes as depicted in FIG. 4. Thus, even if a malicious node sends the same information to all nodes in a particular neighborhood, because the receiving node may be part of another neighborhood that the malicious node is also a part of, the receiving node may detect discrepancies. Referring to FIG. 4, if, for example, node 3 sends different information about itself to nodes 1 and 2, nodes 1 and 2 will be able to detect node 3 as a malicious node based on the comparison of the respective received information.

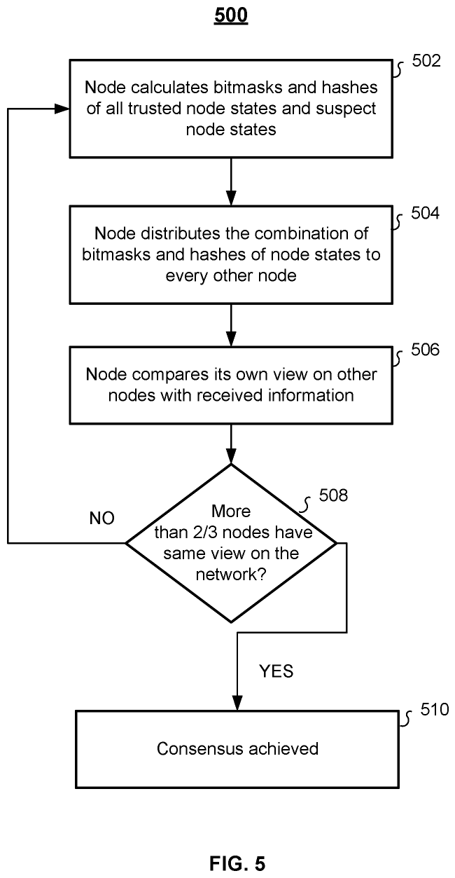

FIG. 5 is a flow diagram of method 500 illustrating a third and fourth phase of consensus, according to exemplary aspects of the present disclosure. Phase 3 involves the distribution of hashed vectors. Unlike a traditional BFT where full states are sent to various nodes, during phase 3, only a small amount of information is exchanged between nodes in order to minimize traffic.

At 502, each node calculates a bitmask for every other node known to it. The bitmask may take the following values: “0” indicating that no phase 1 data was received, “1” indicating that only phase 1 data was received, “2” indicating that only phase 2 data was received, “3” indicating that the phase 2 data to consider a node trusted exceed a threshold, and “4” indicating that a given node is a fraud suspect. The threshold is adjusted based on a probability of a malicious node being located. For example, if the network is trusted, the threshold may be very small and phase 2 only serves as some copy of phase 1. If the network is not trusted, the threshold may be a very high value. At 502, each node 112 may also calculate two separate hashes: (1) a hash of all trusted node states and (2) a hash of all suspect node states.

At 504, each node 112 distributes the combination of the bitmasks and hashes of node states in phase 3 packets to every other node. As discussed before, this may result in a total of N×(N−1) communications. The total size of the phase 3 packet is of the order of N×2.5 bits+k×512 bits, where k may equal 2 (one for trusted nodes, another for potential malicious nodes).

In response to receiving a phase 3 packet, at 506, each node 112 compares the information about nodes obtained from the packet to information already known to itself. In particular, at 508, a determination is made whether at least ⅔ of all nodes in network 110 have the same view (e.g., matching bitmasks and hashes) of network 110. In response to a determination that at least ⅔ of all nodes have the same view of network 110, method 500 ends at 510 because consensus is achieved.

However, if at 508, it is determined that at least ⅔ of all nodes in network 110 do not have the same view, phase 4 is initiated. Phase 4 involves the reconciliation on inconsistent information or loss of information on more than ⅓ nodes. In phase 4, depending on the available information, either phase 3 is repeated (method 500 returns to 502 from 508) or additional communication between particular nodes are performed to clarify suspicious situations/delays.

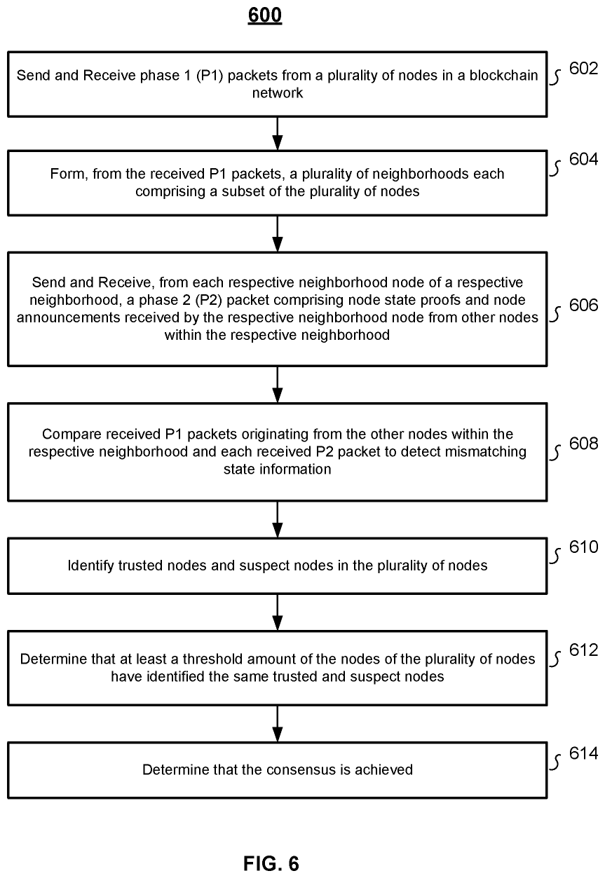

FIG. 6 is a flow diagram illustrating a method for achieving a consensus. At 602, a node sends and receives phase 1 (P1) packets from a plurality of nodes in a blockchain network, wherein each P1 packet comprises a respective node state proof (NSP), respective pulse data, and a respective node announcement of a respective node, wherein the respective node state proof is a signed hash value of a work log completed by the respective node.

At 604, the node forms, from the received P1 packets, a plurality of neighborhoods each comprising a subset of the plurality of nodes.

At 606, the node sends and receives, from each respective neighborhood node of a respective neighborhood, a phase 2 (P2) packet comprising node state proofs and node announcements received by the respective neighborhood node from other nodes within the respective neighborhood.

At 608, the node compares received P1 packets originating from the other nodes within the respective neighborhood and each received P2 packet to detect mismatching state information.

At 610, based on the comparing, the node identifies trusted nodes and suspect nodes in the plurality of nodes.

At 612, the node determines that at least a threshold amount of the nodes of the plurality of nodes have identified the same trusted and suspect nodes, and at 614, the node determines that the consensus is achieved.

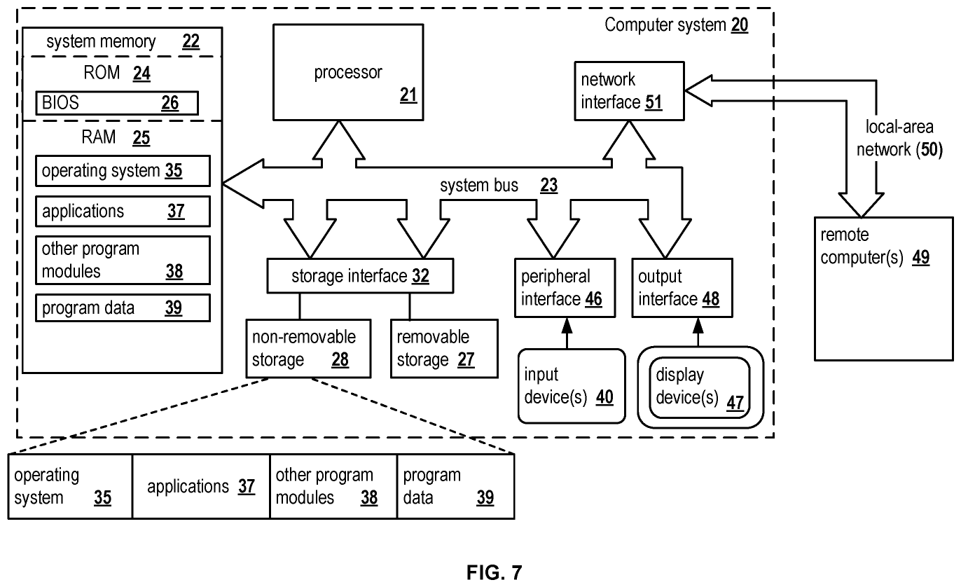

FIG. 7 is a block diagram illustrating a computer system 20 on which aspects of systems and methods for achieving consensus in four phases may be implemented in accordance with an exemplary aspect. It should be noted that the computer system 20 could correspond to the client device 102, for example, described earlier. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, Hyper Transport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, static random access memory (SRAM), dynamic random access memory (DRAM), zero capacitor RAM, twin transistor RAM, enhanced dynamic random access memory (eDRAM), extended data output random access memory (EDO RAM), double data rate random access memory (DDR RAM), electrically erasable programmable read-only memory (EEPROM), NRAM, resistive random access memory (RRAM), silicon-oxide-nitride-silicon (SONOS) based memory, phase-change random access memory (PRAM); flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 5, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for achieving a consensus, the method comprising:
sending and receiving phase 1 (P1) packets from a plurality of nodes in a blockchain network, wherein each P1 packet comprises a respective node state proof (NSP), respective pulse data, and a respective node announcement of a respective node, wherein the respective node state proof is a signed hash value of a work log completed by the respective node;
forming, from the received P1 packets, a plurality of neighborhoods each comprising a subset of the plurality of nodes;
sending and receiving, from each respective neighborhood node of a respective neighborhood, a phase 2 (P2) packet comprising node state proofs and node announcements received by the respective neighborhood node from other nodes within the respective neighborhood;
comparing received P1 packets originating from the other nodes within the respective neighborhood and each received P2 packet to detect mismatching state information;
based on the comparing, identifying trusted nodes and suspect nodes in the plurality of nodes; and
in response to determining that at least a threshold amount of the nodes of the plurality of nodes have identified the same trusted and suspect nodes, determining that the consensus is achieved.

2. The method of claim 1, further comprising removing the suspect nodes from participating in subsequent rounds of the consensus.

3. The method of claim 1, wherein identifying the trusted nodes and the suspect nodes in the plurality of nodes comprises:
identifying, in the received P1 packets, first state information received from a first node;
identifying, in a received P2 packet, second state information received from the first node by a second node of the respective neighborhood;
in response to determining that the first state information and the second state information do not match, identifying the first node as one of the suspect nodes; and
in response to determining that the first state information and the second state information match, identifying the first node as one of the trusted nodes.

4. The method of claim 1, further comprising determining a size of each respective neighborhood of the plurality of neighborhoods such that the plurality of neighborhoods do not share a same node and minimize communication traffic between the plurality of nodes.

5. The method of claim 1, wherein the threshold amount of nodes is at least ⅔ of the plurality of nodes.

6. The method of claim 1, wherein identifying the trusted nodes and the suspect nodes further comprises:
calculating a hash and bitmask of each of the trusted nodes and the suspect nodes for distribution to the plurality of nodes in phase 3 (P3) packets.

7. The method of claim 1, further comprising:
calculating a NSP for transmittal to at least one node of the plurality of nodes in at least one P1 packet in response to receiving a pulse comprising a timestamp, a sequence number and entropy, wherein the pulse is a signal indicating a new processing cycle.

8. The method of claim 7, wherein calculating the NSP comprises:
determining whether the NSP calculation is complete after a pre-defined timeout has expired;
in response to determining that the NSP calculation is not complete, transmitting the at least one P1 packet without the NSP to the at least one node; and
subsequently transmitting the NSP to the at least one node when the NSP calculation is complete.

9. The method of claim 1, wherein communication between Globulas is carried out through a leader-based protocol, wherein a first Globula comprises the plurality of nodes.

10. The method of claim 9, wherein a leader of the Globula is selected by data based on a previous processing cycle.

11. A system for achieving a consensus, the system comprising:
a hardware processor configured to:
send and receive phase 1 (P1) packets from a plurality of nodes in a blockchain network, wherein each P1 packet comprises a respective node state proof (NSP), respective pulse data, and a respective node announcement of a respective node, wherein the respective node state proof is a signed hash value of a work log completed by the respective node;
form, from the received P1 packets, a plurality of neighborhoods each comprising a subset of the plurality of nodes;
send and receive, from each respective neighborhood node of a respective neighborhood, a phase 2 (P2) packet comprising node state proofs and node announcements received by the respective neighborhood node from other nodes within the respective neighborhood;
compare received P1 packets originating from the other nodes within the respective neighborhood and each received P2 packet to detect mismatching state information;
based on the comparing, identify trusted nodes and suspect nodes in the plurality of nodes; and
in response to determining that at least a threshold amount of the nodes of the plurality of nodes have identified the same trusted and suspect nodes, determine that the consensus is achieved.

12. The system of claim 11, wherein the hardware processor is further configured to remove the suspect nodes from participating in subsequent rounds of the consensus.

13. The system of claim 11, wherein the hardware processor is further configured to identify the trusted nodes and the suspect nodes in the plurality of nodes by:
identifying, in the received P1 packets, first state information received from a first node;
identifying, in a received P2 packet, second state information received from the first node by a second node of the respective neighborhood;
in response to determining that the first state information and the second state information do not match, identifying the first node as one of the suspect nodes; and
in response to determining that the first state information and the second state information match, identifying the first node as one of the trusted nodes.

14. The system of claim 11, wherein the hardware processor is further configured to determine a size of each respective neighborhood of the plurality of neighborhoods such that the plurality of neighborhoods do not share a same node and minimize communication traffic between the plurality of nodes.

15. The system of claim 11, wherein the threshold amount of nodes is at least ⅔ of the plurality of nodes.

16. The system of claim 11, wherein the hardware processor is further configured to identify the trusted nodes and the suspect nodes by:
calculating a hash and bitmask of each of the trusted nodes and the suspect nodes for distribution to the plurality of nodes in phase 3 (P3) packets.

17. The system of claim 11, wherein the hardware processor is further configured to:
calculate a NSP for transmittal to at least one node of the plurality of nodes in at least one P1 packet in response to receiving a pulse comprising a timestamp, a sequence number and entropy, wherein the pulse is a signal indicating a new processing cycle.

18. The system of claim 17, wherein the hardware processor is further configured to calculate the NSP by:
determining whether the NSP calculation is complete after a pre-defined timeout has expired;
in response to determining that the NSP calculation is not complete, transmitting the at least one P1 packet without the NSP to the at least one node; and
subsequently transmitting the NSP to the at least one node when the NSP calculation is complete.

19. The system of claim 11, wherein communication between Globulas is carried out through a leader-based protocol, wherein a first Globula comprises the plurality of nodes.

20. A non-transitory computer readable medium storing thereon computer executable instructions for achieving a consensus, including instructions for:
sending and receiving phase 1 (P1) packets from a plurality of nodes in a blockchain network, wherein each P1 packet comprises a respective node state proof (NSP), respective pulse data, and a respective node announcement of a respective node, wherein the respective node state proof is a signed hash value of a work log completed by the respective node;
forming, from the received P1 packets, a plurality of neighborhoods each comprising a subset of the plurality of nodes;
sending and receiving, from each respective neighborhood node of a respective neighborhood, a phase 2 (P2) packet comprising node state proofs and node announcements received by the respective neighborhood node from other nodes within the respective neighborhood;
comparing received P1 packets originating from the other nodes within the respective neighborhood and each received P2 packet to detect mismatching state information;
based on the comparing, identifying trusted nodes and suspect nodes in the plurality of nodes; and
in response to determining that at least a threshold amount of the nodes of the plurality of nodes have identified the same trusted and suspect nodes, determining that the consensus is achieved.
